(19) United States
(12) Patent Application Publication
(10) Pub. No.: US 2026/0119202 A1
(43) Pub. Date: Apr. 30, 2026

(54) ADAPTIVE USER INTERFACE GENERATION AND PROCESS MODIFICATION

(71) Applicant: INTUIT INC., Mountain View, CA (US)

(72) Inventors: Siddharth JAIN, Mountain View, CA (US); Sivashanker THIRUCHITTAMPALAM, Toronto (CA); Venkat Narayan VEDAM, Mountain View, CA (US)

(73) Assignee: INTUIT INC., Mountain View, CA (US)

(21) Appl. No.: 18/926,128

(22) Filed: Oct. 24, 2024

(51) Int. Cl. G06F 9/451

(52) U.S. Cl. CPC G06F 9/451

(57) ABSTRACT

At least one processor may receive data indicating a sequence of actions. The at least one processor may generate a unified embedding from the sequence of actions, wherein the unified embedding can encode respective embeddings of the respective actions encapsulating action characteristics and sequential positions and respective importance scores of the respective actions. The at least one processor may process the unified embedding with a trained machine learning model to thereby predict a next likely action. The at least one processor can configure a user interface or other computer element to perform and/or enable the next likely action in response to the predicting.

### BACKGROUND

Many user interfaces (UIs), such as web-based UIs, are static or semi-static interfaces that cannot dynamically adapt to the fluctuating preferences and contextual needs of individual users. Traditional interfaces lack the ability to evolve in real-time or near real-time based on user behavior and environmental context, resulting in a suboptimal user experience that does not fully engage or satisfy users. This is due to technical limitations of the UIs, which are generally configured to statically provide required functionality in a resource-efficient manner, but lacking technical features that would enable real-time, automatic customization.

To the extent dynamic features have been added to UIs, such as web interfaces, these features are generally quite limited in scope. For example, recommendation systems can analyze user behavior to suggest content or products but do not provide real-time analysis and interface adaptation based on user interaction sequences during a session. Some web services personalize content based on historical data but do not dynamically modify an interface in real-time based on ongoing user actions. Virtual assistants like Siri and Google Assistant can adapt response content based on context but do not provide comprehensive UIs that evolve based on user interactions.

### BRIEF DESCRIPTIONS OF THE DRAWINGS

FIG. 1 shows an example adaptive UI generation and/or process modification system according to some embodiments of the disclosure.

FIG. 2 shows an example process of adaptive UI generation and/or process modification according to some embodiments of the disclosure.

FIG. 3 shows an example unified embedding generation process according to some embodiments of the disclosure.

FIG. 4 shows an example prediction process according to some embodiments of the disclosure.

FIG. 5 shows an example provisioning process according to some embodiments of the disclosure.

FIG. 6 shows an example computing device according to some embodiments of the disclosure.

### DETAILED DESCRIPTION OF SEVERAL EMBODIMENTS

Systems and methods described herein can provide a real-time adaptive UI that leverages unified user interaction embeddings and contextual data processing. By employing advanced attention mechanisms and predictive modeling, disclosed embodiments can dynamically adjust the UI in response to real-time user actions and contextual factors, ensuring a highly personalized and responsive user experience. This continuous adaptation enhances user engagement by anticipating user needs and optimizing the interface accordingly. Some embodiments described herein can adapt the same techniques to any sequence of computer operations, not limited to UI operations, providing real-time customization of active processes in a variety of contexts.

Systems and methods described herein provide a technical solution serving as an alternative and improvement to the inherent rigidity of modern web UIs and other computing processes, which fail to sufficiently adapt to the fluctuating conditions and unique preferences of individual users. As described in detail below, the disclosed embodiments can use embedding techniques and predictive modeling to identify and implement dynamic real-time modifications, predicated on a comprehensive analysis of data such as user actions, contextual data such as location, time of day, application context, and/or contemporaneous and historical user activity patterns. For example, embodiments described herein can encode user interactions as they occur, forming an input to an attention mechanism that can predict a next action based on the encoded input. Before the next action can take place, a UI can be updated in real time to enable or expedite the predicted next action. This real-time adaptability allows the disclosed embodiments to perpetually optimize computing systems to an ongoing situation, such as optimizing a UI to each user's distinctive interaction style and context.

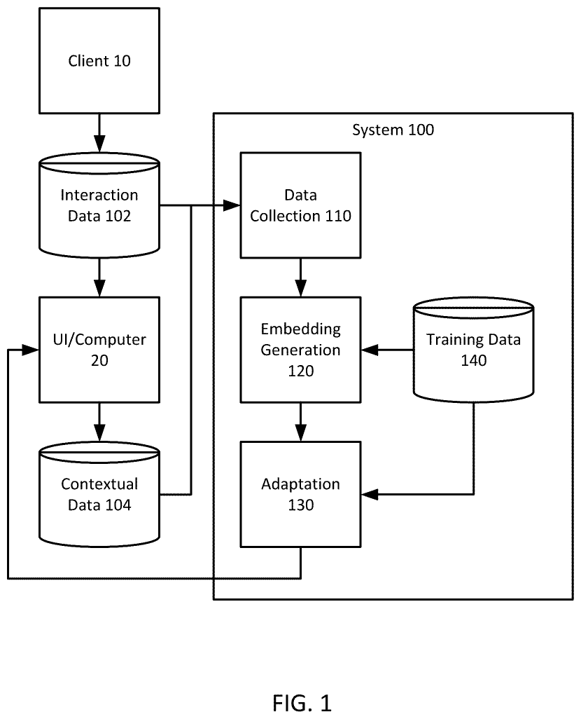

FIG. 1 shows an example adaptive UI generation and/or process modification system 100 according to some embodiments of the disclosure. System 100 may include a variety of hardware, firmware, and/or software components that interact with one another and/or with external components, such as client 10 and/or UI/computer 20, wherein the UI and/or computer 20 is the computing process being modified by operation of system 100. The components of system 100 can include, for example, data collection module 110, embedding generation module 120, and/or adaptation module 130. System 100 can use data from a variety of sources, such as interaction data 102, contextual data 104, and/or training data 122, as described in detail below. While not illustrated as such, UI and/or computer 20 may be included within system 100 in some embodiments. These elements are described in greater detail below, but in one example not intended to limit all embodiments, a user of client 10 can interact with UI 20, which may generate interaction data 102 during ongoing interaction, and/or which may utilize contextual data 104. Data collection module 110 can collect interaction data 102 and/or contextual data 104, for example on an ongoing basis. Embedding generation module 120 can convert the collected data into meaningful, high-dimensional embeddings. Adaptation module 130 can use the embeddings as inputs to predictive modeling processing to dynamically modify UI 20. In some embodiments, system 100 and/or some other process can train ML models used by embedding generation module 120 and/or adaptation module 130 on training data 140 that may include, for example, newly collected interaction data and/or contextual data in a feedback loop for continuous learning.

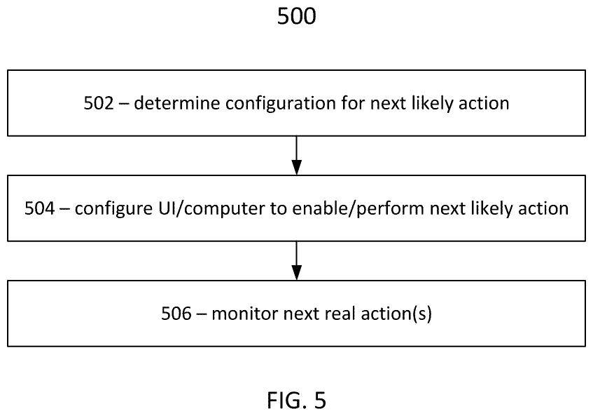

Some components within system 100 may communicate with one another using networks and/or locally. Some components may communicate with external components, such as client 10 and/or UI/computer 20, through one or more networks (e.g., the Internet, an intranet, and/or one or more networks that provide a cloud environment) and/or by other modes of data transfer. Each component may be implemented by one or more computers (e.g., as described below with respect to FIG. 5).

Elements illustrated in FIG. 1 (e.g., system 100 (including data collection module 110, embedding generation module 120, and/or adaptation module 130), client 10, and/or UI/computer 20) are each depicted as single blocks for ease of illustration, but those of ordinary skill in the art will appreciate that these may be embodied in different forms for different implementations. For example, while client 10, UI/computer 20, and system 100 are depicted separately, any combination of these elements may be part of a combined hardware, firmware, and/or software element. Likewise, while various elements such as data collection module 110, embedding generation module 120, and adaptation module 130 are depicted as parts of a single system 100, any combination of these elements may be distributed among multiple logical and/or physical locations. Also, while one client 10, one UI/computer 20, and one system 100 are illustrated, this is for clarity only, and multiples of any of the above elements may be present. In practice, there may be single instances or multiples of any of the illustrated elements, and/or these elements may be combined or co-located.

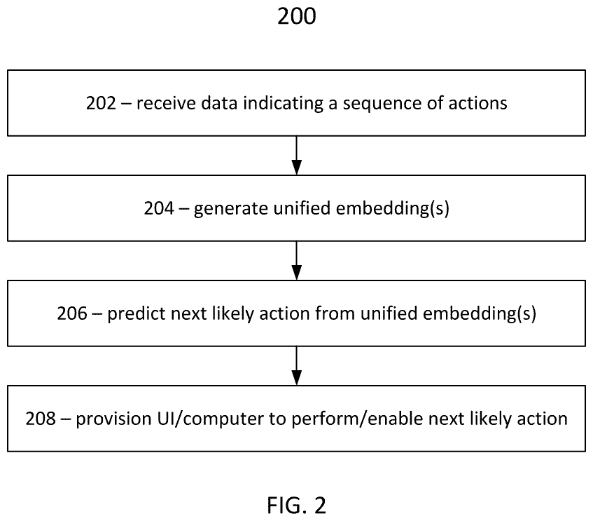

As described in detail below, system 100 can perform processing to update UI/computer 20 in real time to anticipate next processing steps, such as by providing UI element(s) likely to be needed by a user of client 10 and/or provisioning computer 20 to perform other processing that is predicted to come next. For example, FIGS. 2-4 illustrate the functioning of the illustrated components in detail.

In the following descriptions of how system 100 functions, several examples are presented. However, those of ordinary skill in the art will appreciate that these examples are merely for illustration, and system 100 and its methods of use and operation are extendable to other application and data contexts.

FIG. 2 shows an example process 200 of adaptive UI generation and/or process modification according to some embodiments of the disclosure. System 100 can perform process 200 to predict future actions in an ongoing sequence of actions and configure one or more computers (e.g., UI/computer 20) to enable and/or perform such future actions in an anticipatory, real-time manner. Process 200 is described primarily in the context of an example wherein the sequence of actions includes actions by a user of client 10 interacting with UI 20, and configuring UI 20 includes preparing UI element(s) for the predicted next action, it should be understood that process 200 may be performed in other computing contexts in other embodiments.

At 202, system 100 can receive data indicating a sequence of actions performed by a computer during a computing process. For example, data collection module 110 can receive real-time data as the sequence progresses. The data can include interaction data 102, such as user data generated by one or more of client 10 and UI 20 indicating a sequence of UI actions performed as a result of the user interacting with UI 20. Interaction data 102 may include the types of actions performed (e.g., clicks, navigation, inputs, elements used such as widgets and/or plugins, etc.) and the sequence in which these actions occur. The data can include contextual data 104, which may be other data relevant to the UI actions such as stored user profile data, time and/or day data, location data, network data, session data, navigation data such as a source from which the user accessed UI 20, and/or other data relevant to the sequence of actions.

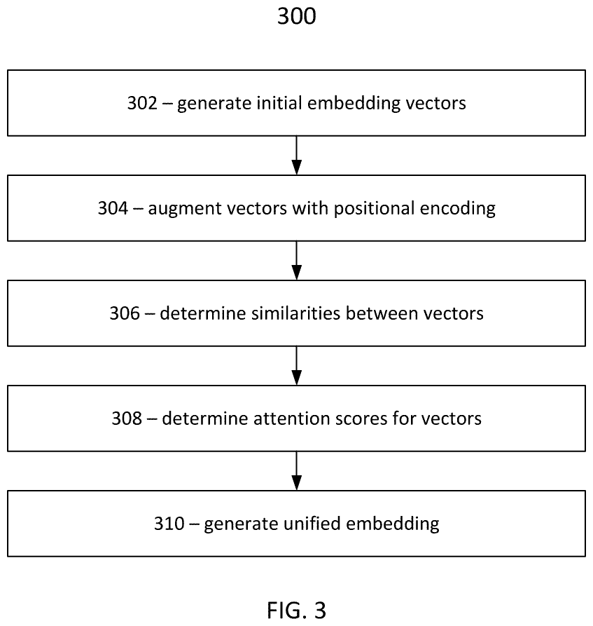

At 204, system 100 can generate at least one unified embedding from the sequence of actions. The unified embedding can encode respective embeddings of the respective actions encapsulating action characteristics and sequential positions and/or respective importance scores of the respective actions. A detailed description of unified embedding generation is given below with reference to FIG. 3.

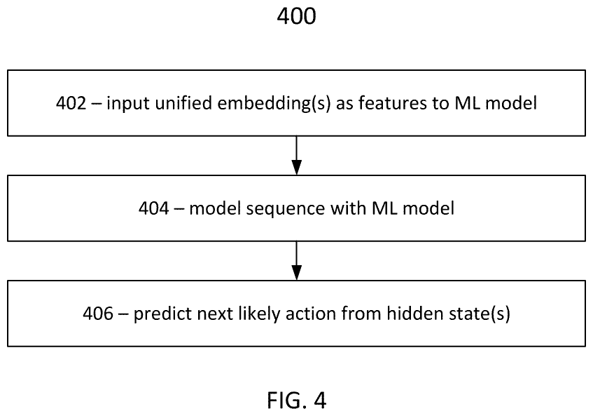

At 206, system 100 can predict a next likely action within the computing process, for example by processing the unified embedding with a trained ML model. The next likely action can be, for example, a next likely action by the user within the UI, which therefore may suggest one or more UI resources that will be used next. A detailed description of prediction is given below with reference to FIG. 4.

At 208, system 100 can provision UI and/or computer 20 to perform and/or enable the next likely action predicted at 206. For example, system 100 can modify the UI to add or change a UI element that enables the next likely action, or otherwise configure the computer to perform the next likely action, in response to the predicting. Examples of provisioning are described in detail below with respect to FIG. 5.

FIG. 3 shows an example unified embedding generation process 300 according to some embodiments of the disclosure. For example, embedding generation module 120 of system 100 can perform process 300 to generate a unified embedding for a sequence using data collected by data collection module 110 (e.g., at 202 of process 200). By performing process 300, system 100 can convert interaction and contextual data into high-dimensional embeddings, incorporating both action features and positional encoding, and calculate similarity scores between embeddings to prioritize significant user actions and generate unified embeddings.

At 302, embedding generation module 120 can generate initial embedding vectors. For example, for each respective action (e.g., UI 20 action by user of client 10) in the sequence, embedding generation module 120 may transform the respective action into an initial embedding vector representing at least one feature of the respective action. For example, embedding generation module 120 can transform each user action into an initial embedding vector (ai) which may represent the action's inherent features.

At 304, embedding generation module 120 can augment vectors generated at 302 (e.g., each respective initial embedding vector) with positional encoding, which may include using at least one of a sine function and a cosine function. To incorporate sequence information providing contextual understanding, each action embedding can be augmented with a positional encoding using sine and cosine functions, for example as follows:

$${pos}_{i} [ 2 k ] = sin ( \frac{i}{{10000}^{\frac{2 k}{d}}} ) ; {pos}_{i} [ 2 k + 1 ] = cos ( \frac{i}{{10000}^{\frac{2 k}{d}}} )$$

Here, (d) denotes the dimensionality of the embeddings. The resulting combined embedding (e′ᵢ) may be as follows:

$${e}_{i}^{′} = {a}_{i} + {pos}_{i}$$

The combined embedding can now encapsulate both the specific characteristics of the action and its position in the sequence, enriching the dataset with spatial and temporal context. For example, for a sequence a1->a2->a3, assume the initial action embeddings to be as follows:

$${e}_{a 1} = [ 1.024 , 0.754 ]$$

$${e}_{a 2} = [ 0.434 , 0.141 ]$$

$${e}_{a 3} = [ 0.535 , 1.312 ]$$

The positional embeddings may be as follows:

$${pos}_{1} = [ 0.023 , 0.042 ]$$

$${pos}_{2} = [ 0.001 , 0.022 ]$$

$${pos}_{3} = [ 0.002 , 0.078 ]$$

The combined embeddings may be as follows:

$${e}_{1}^{′} = [ 1.047 , 0.796 ]$$

$${e}_{2}^{′} = [ 0.435 , 0.163 ]$$

$${e}_{3}^{′} = [ 0.537 , 1.39 ]$$

At 306, embedding generation module 120 can determine similarities between vectors as augmented at 304 which may include, for example, determining respective similarity scores of respective pairs of the respective embeddings. The similarity scores can indicate the influence of actions upon each other. For example, embedding generation module 120 can compute similarity scores between all pairs of action embeddings using the dot product as follows:

$${s}_{ij} = {e}_{i}^{′} \cdot {e}_{j}^{′}$$

Taking the above example, sᵢⱼ can be as follows:

$${s}_{12} = {e}_{1}^{′} \cdot {e}_{2}^{′} = 0.585$$

$${s}_{23} = {e}_{2}^{′} \cdot {e}_{3}^{′} = 0.46$$

$${s}_{13} = {e}_{1}^{′} \cdot {e}_{3}^{′} = 1.668$$

These scores can establish how actions are related or influenced by one another, serving as the foundation for the attention mechanism.

At 308, embedding generation module 120 can determine attention scores for vectors which may include, for example, calculating a probability distribution containing the respective importance scores using an attention mechanism such as a softmax function taking the respective similarity scores as inputs. For example, embedding generation module 120 can calculate attention scores using a softmax function to normalize the similarity scores into a probability distribution representing the relative importance of each action within the context of others:

$${α}_{ij} = \frac{exp ( {s}_{ij} )}{{\sum }_{k} exp ( {s}_{ik} )}$$

Continuing the example above, the attention scores may be as follows:

$${α}_{12} = \frac{exp ( {s}_{12} )}{exp ( {s}_{12} ) + exp ( {s}_{23} ) + exp ( {s}_{13} )} = \frac{1.59}{7.374} = 0.215$$

$${α}_{23} = \frac{exp ( {s}_{23} )}{exp ( {s}_{12} ) + exp ( {s}_{23} ) + exp ( {s}_{13} )} = \frac{1.25}{7.374} = 0.169$$

$${α}_{13} = \frac{exp ( {s}_{13} )}{exp ( {s}_{12} ) + exp ( {s}_{23} ) + exp ( {s}_{13} )} = \frac{4.534}{7.374} = 0.614$$

This attention mechanism can ensure that more significant actions have a profound influence on the model's output, focusing the following processing on the most pivotal aspects of the user's interaction sequence.

At 310, embedding generation module 120 can generate a unified embedding for the sequence. Utilizing the attention scores, embedding generation module 120 may aggregate the sequence embeddings into a single vector that succinctly summarizes the entire sequence within the context of an action, for example as follows:

$${e}_{i}^{″} = {\sum }_{\text{?}} {α}_{ij} {e}_{j}^{′}$$

$$\text{?} \text{indicates text missing or illegible when filed}$$

Continuing with the above embedding examples, the aggregated embedding scores for each action can be as follows:

$${e}_{1}^{″} = {α}_{12} \cdot {e}_{2}^{′} + {α}_{13} \cdot {e}_{3}^{′} = [ 0.093 , 0.035 ] + [ 0.329 , 0.853 ] = [ 0.422 , 0.888 ]$$

$${e}_{2}^{″} = {α}_{23} \cdot {e}_{3}^{′} = [ 0.09 , 0.234 ]$$

Embedding generation module 120 can calculate the action sub-sequence scores, for example as follows:

$${s}_{12} = {e}_{1}^{″} + {e}_{2}^{″} = [ 0.512 , 1.122 ]$$

$${s}_{23} = {e}_{2}^{″} = [ 0.09 , 0.234 ]$$

Finally, for the action sequence a1->a2->a3, embedding generation module 120 can calculate the seq score (C_{seq}) as follows:

$${C}_{seq} = \frac{1}{n} {\sum }_{n} {s}_{in}$$

In the continuing example, the seq score may be as follows:

$${C}_{seq ( 123 )} = \frac{( {s}_{12} + {s}_{23} )}{2} = [ 0.301 , 0.678 ]$$

Embedding generation module 120 can average the aggregated embedding (C_{seq}) across all actions to create a comprehensive representation of the user's session. To enhance this representation further, embedding generation module 120 can integrate contextual data (C_{context}) such as application context, user preferences, and other external factors into the sequence embedding (e.g., in the form of relevant embedding vectors), for example as follows:

$${C}_{unified} = [ {C}_{seq} ; {C}_{context} ]$$

Finally, assume the C_{context} embeddings come out as follows:

$${C}_{context} = [ 1.124 , 0.734 ]$$

Embedding generation module 120 can calculate unified embeddings using the above formula, so the final embeddings may be as follows:

$${C}_{unified} = [ 1.425 , 1.412 ]$$

This unified embedding can provide a holistic view of both the user's current session and broader context, making it an invaluable input for predicting the user's next likely action.

FIG. 4 shows an example prediction process 400 according to some embodiments of the disclosure. For example, adaptation module 130 of system 100 can perform process 400 to generate a prediction of a next action in a sequence from a unified embedding for the (e.g., as generated by process 300). By performing process 400, system 100 can utilize the meticulously crafted unified embeddings to perform sophisticated predictive modeling to enable proactive and/or responsive UI/computer 20 adjustments.

At 402, adaptation module 130 can input unified embedding(s), such as those generated by embedding generation module 120 performing process 300, as features to a ML model. The ML model, which can be a recurrent neural network (RNN) in some embodiments, may have been trained on sequences of unified embeddings. Each training instance can include a sequence of actions represented by their corresponding unified embeddings, (C_{unified}), with the target being the next action in the sequence. This training may teach the model to recognize patterns and dependencies between sequences of actions and subsequent user behaviors.

Once the unified embeddings are generated, encapsulating both the sequence of user interactions and the contextual data, adaptation module 130 can receive the unified embeddings from embedding generation module 120. The unified embeddings can serve as comprehensive features that encapsulate not only the individual actions and their temporal positions but also the contextual settings in which these actions occurred. This rich dataset can allow the ML model to understand nuanced behaviors and predict future actions with a higher degree of accuracy.

At 404, adaptation module 130 can model the sequence of action using the ML model. The ML model can operate on these unified embeddings (Cunified). For example, let U=[u1, u2, . . . un] be the matrix of embeddings for a sequence of user interactions. An RNN, such as LSTM or GRU, may model the sequence. RNNs may be useful for sequence modeling due to their efficacy in handling temporal dependencies. The RNN may determine a hidden state as follows, for example:

$${h}_{t} = RNN ( {u}_{t} , {h}_{t - 1} )$$

where hₜ is the hidden state at time t, capturing the information of the sequence up to uₜ.

At 406, adaptation module 130 can predict the next likely action for the sequence from the final hidden state or combination of hidden states. For example, adaptation module 130 can select the final hidden state hₙ, or a combination of all hidden states, for use to predict the next likely action. This can be done through a fully connected layer with a softmax function to generate a probability distribution over potential actions, for example as follows:

$$p ( {y}_{n + 1} \vert U ) = softmax ( W \cdot {h}_{n} + b )$$

where W and b are the weights and bias of the prediction layer, respectively, and yₙ+1 is the predicted next action.

In at least some embodiments, the model may be trained by minimizing the loss function, for example cross entropy, between the predicted probabilities and the actual next actions observed in the training data. A backpropagation technique may be used to update the weights of the RNN by back propagating the error from the output back through the network to adjust weights to reduce prediction error.

In deployment, as a user interacts with UI 20, or as another computing process progresses, each action may be processed to update the unified embedding in real-time. This updated embedding is then fed into the trained model to predict the next likely action or series of actions that may occur based on the current context and past behavior patterns that contributed to the training data.

FIG. 5 shows an example provisioning process 500 according to some embodiments of the disclosure. Adaptation module 130 and/or other system 100 components can perform process 500 to configure UI/computer 20. Based on the predictions made by the ML model through performing process 400, adaptation module 130 can dynamically adapt a UI 20 or other computing process, for example. This adaptation is not just reactive but anticipative, adjusting the interface in ways that are most likely to align with the user's needs. For example, based on the predicted next actions, specific components of the application such as widgets, menus, or even entire layouts can be pre-loaded or highlighted. For instance, if the model predicts that a user is likely to access a help feature next, the interface can proactively bring the help options into a more prominent position. Beyond individual components, the adaptation module 130 can adjust the overall layout and themes of UI 20 to better suit the predicted needs. If a user's behavior suggests a preference for certain types of interactions at specific times (e.g., simplified interfaces during busy morning hours), the interface can adapt accordingly.

At 502, adaptation module 130 can determine a UI/computer 20 configuration that may enable and/or cause performance of the next likely action. For example, UI/computer 20 may be configured by an app shell or app rendering paradigm, which may be static by default. Adaptation module 130 can make this app shell or app rendering paradigm by looking up components needed for the next likely action in a registry where all the specifications for the components reside. For example, adaptation module 130 can search the registry for the next likely action and/or a widget or component name or description associated with the next likely action. Because the next likely action prediction can predict the application context that the widget requires and/or what the widget uses, adaptation module 130 can pull the widget parameters and, in some embodiments, can pre fill with context information.

At 504, adaptation module 130 can configure UI/computer 20 to enable and/or perform the next likely action. This may include, for example, fetching at least one component or parameter of the UI element or other element from at least one data store and configuring the UI/computer 20 to include the at least one component or parameter. In some embodiments, this may further include configuring a variable portion of the UI element with context data determined from the user data (e.g., pre-filling forms or pre-selecting options to correspond with the content of interaction data 102 and/or contextual data 104. Accordingly, adaptation module 130 can dynamically adjusts UI/computer 20 based on predictions, thereby optimizing layout, component visibility, and user engagement, for example.

At 506, data collection module 110 can monitor the next real action(s) taking place after the configuring. For example, as the user of client 10 interacts with the dynamically adapted interface, their actions (e.g., interaction data 102) may continue to be logged by data collection module 110 and fed back into the system (e.g., at 202 of process 200). This ongoing data collection not only helps in continuously refining the accuracy of predictions but also ensures that the interface evolves with changing user preferences and behaviors.

By utilizing the unified embeddings for predictive modeling, system 100 can leverage deep insights into user behavior patterns to anticipate future actions. This approach can enable a dynamic adaptation of the interface that is not only responsive to, but also anticipatory of, user needs, thereby enhancing engagement and satisfaction. The integration of real-time data processing and adaptive interface technology represents a significant leap forward in personalized user experience design and proactive, real-time system configuration.

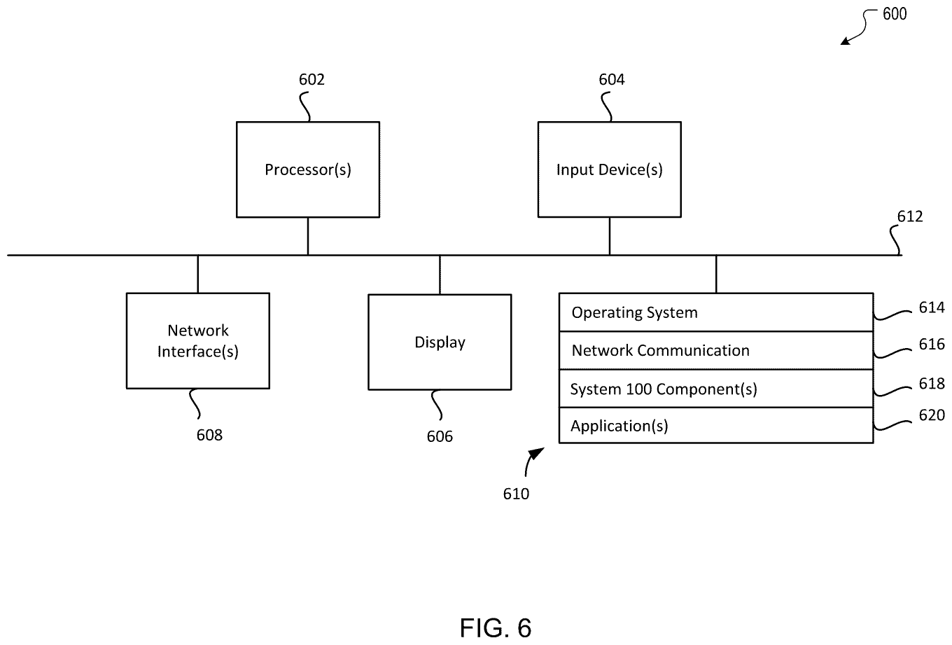

FIG. 6 shows a computing device 600 according to some embodiments of the disclosure. For example, computing device 600 may function as a single system 100 or any portion(s) thereof, or multiple computing devices 600 may function as a system 100.

Computing device 600 may be implemented on any electronic device that runs software applications derived from compiled instructions, including without limitation personal computers, servers, smart phones, media players, electronic tablets, game consoles, email devices, etc. In some implementations, computing device 600 may include one or more processors 602, one or more input devices 604, one or more display devices 606, one or more network interfaces 608, and one or more computer-readable mediums 610. Each of these components may be coupled by bus 612, and in some embodiments, these components may be distributed among multiple physical locations and coupled by a network.

Display device 606 may be any known display technology, including but not limited to display devices using Liquid Crystal Display (LCD) or Light Emitting Diode (LED) technology. Processor(s) 602 may use any known processor technology, including but not limited to graphics processors and multi-core processors. Input device 604 may be any known input device technology, including but not limited to a keyboard (including a virtual keyboard), mouse, track ball, and touch-sensitive pad or display. Bus 612 may be any known internal or external bus technology, including but not limited to ISA, EISA, PCI, PCI Express, NuBus, USB, Serial ATA or FireWire. In some embodiments, some or all devices shown as coupled by bus 612 may not be coupled to one another by a physical bus, but by a network connection, for example. Computer-readable medium 610 may be any medium that participates in providing instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 610 may include various instructions 614 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 604; sending output to display device 606; keeping track of files and directories on computer-readable medium 610; controlling peripheral devices (e.g., disk drives, printers, etc.) which can be controlled directly or through an I/O controller; and managing traffic on bus 612. Network communications instructions 616 may establish and maintain network connections (e.g., software for implementing communication protocols, such as TCP/IP, HTTP, Ethernet, telephony, etc.).

System 100 components 618 may include the system elements and/or the instructions that enable computing device 600 to perform functions of system 100 as described above. Application(s) 620 may be an application that uses or implements the outcome of processes described herein and/or other processes. In some embodiments, the various processes may also be implemented in operating system 614.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In some cases, instructions, as a whole or in part, may be in the form of prompts given to a large language model or other machine learning and/or artificial intelligence system. As those of ordinary skill in the art will appreciate, instructions in the form of prompts configure the system being prompted to perform a certain task programmatically. Even if the program is non-deterministic in nature, it is still a program being executed by a machine. As such, “prompt engineering” to configure prompts to achieve a desired computing result is considered herein as a form of implementing the described features by a computer program.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by at least one processor, user data indicating a sequence of user interface (UI) actions;
generating, by the at least one processor, a unified embedding from the sequence of UI actions, the unified embedding encoding:
respective embeddings of the respective UI actions encapsulating UI action characteristics and sequential positions, and
respective importance scores of the respective UI actions;
predicting, by the at least one processor processing the unified embedding with a trained machine learning (ML) model, a next likely action by the user within the UI; and
modifying, by the at least one processor, the UI to add or change a UI element that enables the next likely action in response to the predicting.

2. The method of claim 1, wherein the generating comprises generating the respective embeddings by performing, for each of the respective UI actions, processing comprising:
transforming the respective UI action into an initial embedding vector representing at least one feature of the respective UI action;
generating a positional encoding of the respective UI action; and
combining the initial embedding vector and the positional encoding to form the respective embedding.

3. The method of claim 2, wherein generating the positional encoding is performed using at least one of a sine function and a cosine function.

4. The method of claim 1, wherein the generating comprises generating the respective importance scores by performing, for each of the respective UI actions, processing comprising:
determining respective similarity scores of respective pairs of the respective embeddings; and
calculating a probability distribution containing the respective importance scores using an attention mechanism taking the respective similarity scores as inputs.

5. The method of claim 4, wherein the attention mechanism includes a softmax function.

6. The method of claim 1, wherein:
the ML model comprises a recurrent neural network (RNN); and
the predicting comprises modeling the sequence by the RNN using the unified embedding as input and predicting at least one hidden state from the modeling, the at least one hidden state indicating the next likely action.

7. The method of claim 1, wherein the modifying comprises fetching at least one component or parameter of the UI element from at least one data store and configuring the UI to include the at least one component or parameter.

8. The method of claim 7, wherein the modifying further comprises configuring a variable portion of the UI element with context data determined from the user data.

9. A method comprising:
receiving, by at least one processor, data indicating a sequence of actions performed by a computer during a computing process;
generating, by the at least one processor, a unified embedding from the sequence of actions, the unified embedding encoding:
respective embeddings of the respective actions encapsulating action characteristics and sequential positions, and
respective importance scores of the respective actions;
predicting, by the at least one processor processing the unified embedding with a trained machine learning (ML) model, a next likely action within the computing process; and
configuring, by the at least one processor, the computer to perform the next likely action in response to the predicting.

10. The method of claim 9, wherein the generating comprises generating the respective embeddings by performing, for each of the respective actions, processing comprising:
transforming the respective action into an initial embedding vector representing at least one feature of the respective action;
generating a positional encoding of the respective action; and
combining the initial embedding vector and the positional encoding to form the respective embedding.

11. The method of claim 10, wherein generating the positional encoding is performed using at least one of a sine function and a cosine function.

12. The method of claim 9, wherein the generating comprises generating the respective importance scores by performing, for each of the respective actions, processing comprising:
determining respective similarity scores of respective pairs of the respective embeddings; and
calculating a probability distribution containing the respective importance scores using an attention mechanism taking the respective similarity scores as inputs.

13. The method of claim 12, wherein the attention mechanism includes a softmax function.

14. The method of claim 9, wherein:
the ML model comprises a recurrent neural network (RNN); and
the predicting comprises modeling the sequence by the RNN using the unified embedding as input and predicting at least one hidden state from the modeling, the at least one hidden state indicating the next likely action.

15. A system comprising:
at least one processor; and
at least one non-transitory computer-readable medium storing instructions that, when executed by the at least one processor, cause the at least one processor to perform processing comprising:
receiving user data indicating a sequence of user interface (UI) actions;
generating a unified embedding from the sequence of UI actions, the unified embedding encoding:
respective embeddings of the respective UI actions encapsulating UI action characteristics and sequential positions, and
respective importance scores of the respective UI actions;
predicting, by processing the unified embedding with a trained machine learning (ML) model, a next likely action by the user within the UI; and
modifying the UI to add or change a UI element that enables the next likely action in response to the predicting.

16. The system of claim 15, wherein the generating comprises generating the respective embeddings by performing, for each of the respective UI actions, processing comprising:
transforming the respective UI action into an initial embedding vector representing at least one feature of the respective UI action;
generating a positional encoding of the respective UI action; and
combining the initial embedding vector and the positional encoding to form the respective embedding.

17. The system of claim 15, wherein the generating comprises generating the respective importance scores by performing, for each of the respective UI actions, processing comprising:
determining respective similarity scores of respective pairs of the respective embeddings; and
calculating a probability distribution containing the respective importance scores using an attention mechanism taking the respective similarity scores as inputs.

18. The system of claim 15, wherein:
the ML model comprises a recurrent neural network (RNN); and
the predicting comprises modeling the sequence by the RNN using the unified embedding as input and predicting at least one hidden state from the modeling, the at least one hidden state indicating the next likely action.

19. The system of claim 15, further comprising at least one data store, wherein the modifying comprises fetching at least one component or parameter of the UI element from the at least one data store and configuring the UI to include the at least one component or parameter.

20. The system of claim 19, wherein the modifying further comprises configuring a variable portion of the UI element with context data determined from the user data.
